(19) United States
(12) Patent Application Publication
(10) Pub. No.: US 2017/0014875 A1
(43) Pub. Date: Jan. 19, 2017

(54) LABELER AUTOMATED CLEANING SYSTEM

(71) Applicant: Niagara Bottling, LLC, Ontario, CA (US)

(72) Inventors: Kyle Brower, Clemont, FL (US); Casey Winningham, Minneola, FL (US); Daren Ruben, Orlando, FL (US)

(73) Assignee: Niagara Bottling, LLC, Ontario, CA (US)

(21) Appl. No.: 15/206,722

(22) Filed: Jul. 11, 2016

Related U.S. Application Data
(60) Provisional application No. 62/196,775, filed on Jul. 24, 2015.
(60) Provisional application No. 62/194,137, filed on Jul. 17, 2015.

(51) Int. Cl. B08B 9/087

(52) U.S. Cl. CPC B08B 9/087

(57) ABSTRACT

An apparatus for cleaning one or more components of a bottle labeling assembly, the apparatus comprising a pneumatic motor; a cleaning component coupled to the pneumatic motor; the cleaning component including a plurality of bristles and configured to rotate according to operation of the pneumatic motor; a guide rail and bearing coupled to at least one of the cleaning component or the pneumatic motor; and a pneumatic cylinder coupled to the guide rail and bearing and at least one of the cleaning component or the pneumatic motor, the pneumatic cylinder operative to move the cleaning component and the pneumatic motor along the guide rail and bearing is shown.

### PRIORITY

This application claims the benefit of and priority to U.S. Provisional Application No. 62/196,775 filed on Jul. 24, 2015 and U.S. Provisional Application No. 62/194,137 filed Jul. 17, 2015, entitled “Automated Vacuum Drum Cleaning.” the entirety of each said applications being incorporated herein by reference.

### FIELD

The field of the present disclosure generally relates to systems for cleaning drums and conveyor belt devices. More particularly, the field of the present disclosure relates to an apparatus, system and method for automated vacuum drum cleaning associated with bottle handling machinery.

### BACKGROUND

Plastic bottle manufacturing generally requires moving a multiplicity of plastic bottles through a series of stations within bottle manufacturing and filling machinery. Typically, the bottles are placed into a queue which is transported to a destination on a conveyor belt bottle filling assembly. In many instances, the bottles merely rest on the conveyor belt while the belt moves toward the destination. The conveyor belt often times is mounted onto rollers and extended into an elongate configuration suitable for moving the bottles on a top portion of the belt.

A conventional plastic bottle includes a plastic labeling that is typically glued to the bottle. This label is often glued to the plastic bottle while moving past a roller and drum that places glue and the label on the plastic bottle while the plastic bottle is on a conveyor belt. During normal labeling operations, one or more components of the conveyor belt bottle filling assembly may acquire a buildup of glue and/or ink residue. Such a buildup needs to be removed to ensure safe, proper and efficient labeling operations (e.g., clean and consistent application of a plastic label on a plastic bottle).

However, a manual cleaning process may present safety hazards to employees implementing the cleaning process. Additionally, current cleaning processes may interfere with the normal operations of the conveyor belt and filling process, thereby decreasing its efficiency.

### SUMMARY

An apparatus for cleaning one or more components of a bottle labeling assembly, the apparatus comprising a pneumatic motor; a cleaning component coupled to the pneumatic motor; the cleaning component including a plurality of bristles and configured to rotate according to operation of the pneumatic motor; a guide rail and bearing coupled to at least one of the cleaning component or the pneumatic motor; and a pneumatic cylinder coupled to the guide rail and bearing and at least one of the cleaning component or the pneumatic motor, the pneumatic cylinder operative to move the cleaning component and the pneumatic motor along the guide rail and bearing is shown.

In an exemplary embodiment, An automated cleaning system comprising: a cleaning component integrated into a conveyor belt bottle filling assembly; and a pneumatic actuator integrated into the conveyor belt bottle filling assembly and communicatively coupled to the cleaning component to control a movement of the cleaning component for removing residue from a labeling component of the conveyor belt bottle filling assembly.

In another exemplary embodiment, the automated cleaning system wherein the pneumatic actuator is preconfigured to automatically pause the conveyor belt bottle filling assembly at predefined time intervals and initiate a cleaning cycle.

In another exemplary embodiment, automated cleaning system wherein the pneumatic actuator is communicatively coupled to the cleaning component via a mechanical arm, the pneumatic actuator transmits one or more electrical signals to the mechanical arm to control a movement of the cleaning component. The automated cleaning system further comprising: a drying component. The automated cleaning system, wherein the drying component is an air knife mechanism.

In another exemplary embodiment, the automated cleaning system further comprising: a container that holds a cleaning solution; and a spray mechanism coupled to the container, wherein the cleaning solution is dispensed during a cleaning cycle of the automated cleaning system.

In an exemplary embodiment, an apparatus for cleaning one or more components of a bottle labeling assembly, the apparatus comprising: a pneumatic motor; a cleaning component coupled to the pneumatic motor; the cleaning component including a plurality of bristles and configured to rotate according to operation of the pneumatic motor; a guide rail and bearing coupled to at least one of the cleaning component or the pneumatic motor; and a pneumatic cylinder coupled to the guide rail and bearing and at least one of the cleaning component or the pneumatic motor, the pneumatic cylinder operative to move the cleaning component and the pneumatic motor along the guide rail and bearing.

In another exemplary embodiment, the apparatus further comprising: a reservoir to hold a cleaning solution; a spray mechanism to spray the cleaning solution onto the plurality of bristles of the cleaning component; and an atomizer coupled to the reservoir and the spray mechanism, the atomizer to atomize a liquid form of the cleaning solution from the reservoir, wherein the spray mechanism sprays an atomized version of the cleaning solution.

In another exemplary embodiment, the apparatus further comprising: a check valve coupling the reservoir to the atomizer to prevent any backflow into the reservoir.

In another exemplary embodiment, the apparatus further comprising: a housing that houses the spray mechanism, the housing coupling the pneumatic cylinder to the at least one of the cleaning component or the pneumatic motor, wherein the housing directs the spray.

In another exemplary embodiment, the apparatus further comprising: a spray control mechanism to control the amount of spray dispensed by the spray mechanism, the spray control mechanism being coupled to the spray mechanism.

In another exemplary embodiment, the apparatus wherein the pneumatic cylinder moves the cleaning component and the pneumatic motor along the guide rail and bearing in a straight line.

In an exemplary embodiment, a method of cleaning one or more components of a bottle labeling assembly comprising: determining the one or more components of the bottle labeling assembly are empty; moving a cleaning component into contact with the one or more components of the bottle labeling assembly with a pneumatic cylinder; rotating the cleaning component with a pneumatic motor for a predetermined amount of time to remove excess residue; and removing the cleaning component from contact with the one or more components of the bottle labeling assembly with the pneumatic cylinder when the predetermined amount of time has elapsed.

In another exemplary embodiment, the method wherein the cleaning component is moved along a guide rail using the pneumatic cylinder.

In another exemplary embodiment, the method further comprising: atomizing a cleaning solution; and spraying the atomized cleaning solution onto the cleaning component.

In another exemplary embodiment, the method wherein the atomized cleaning solution is sprayed prior to rotating the cleaning component.

### BRIEF DESCRIPTION OF THE DRAWINGS

The drawings refer to embodiments of the present disclosure in which:

FIG. 1 is an embodiment of an automated cleaning system.

FIG. 2 is an embodiment illustrating interactions between components of the automated cleaning system of FIG. 1.

FIG. 3 is an illustration of an example graphical user interface associated with the automated cleaning system of FIG. 1.

FIG. 4 is an illustration of an exemplary embodiment of a cutting drum.

FIG. 5 is a second perspective of the cutting drum of FIG. 4.

FIG. 6 is an exemplary embodiment of an automated cleaning system.

FIG. 7 is a second perspective of the exemplary embodiment as illustrated in FIG. 6.

FIG. 8A is a first example illustration of the housing 180.

FIG. 8B is a second example illustration of the housing 180.

FIG. 8C is a third example illustration of the housing 180.

FIG. 8D is a fourth example illustration of the housing 180.

FIG. 9 is an example illustration of a cleaning component 110 and a spray mechanism 710.

FIG. 10 is a second embodiment of the automated cleaning system of FIG. 1.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first gear plate,” may be made. However, the specific numeric reference should not be interpreted as a literal sequential order but rather interpreted that the “first gear plate” is different than a “second gear plate.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, the present disclosure describes an apparatus, a method and a system for cleaning one or more components that are associated with applying a label to a plastic bottle. In one embodiment, the automated cleaning system includes a cleaning component that interacts with one or more of a vacuum assisted gripper, a cutting drum and/or a glue applicator component to remove excessive glue, ink or other materials (e.g., dirt or dust residue) that have built up on the vacuum assisted gripper and/or the cutting drum.

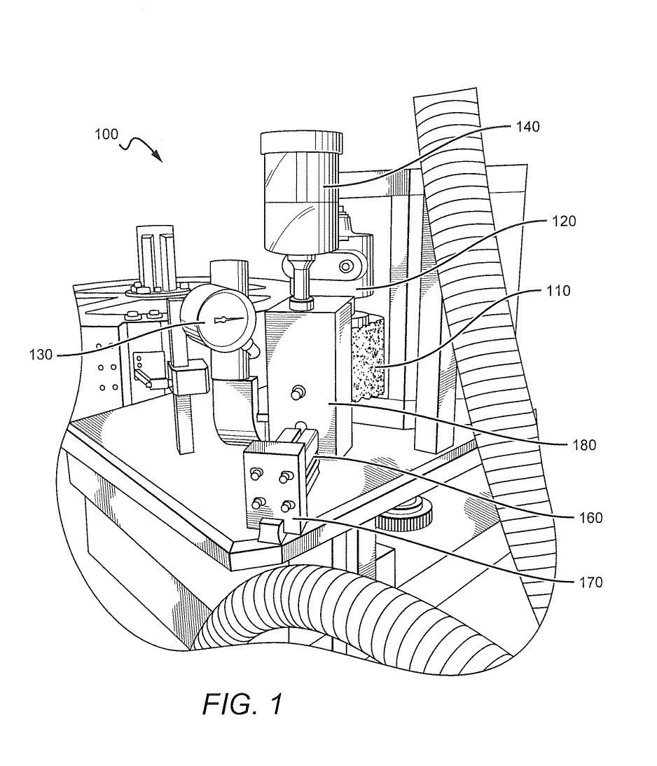

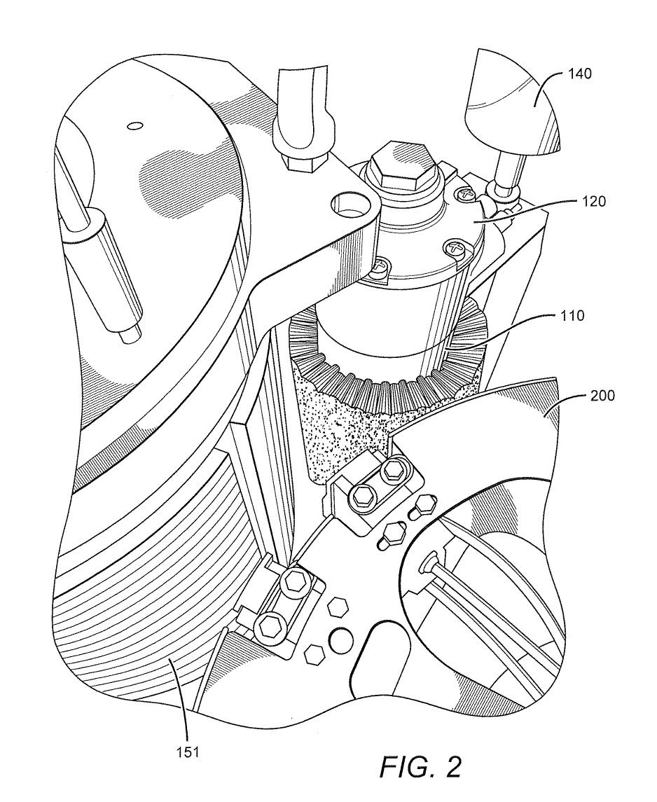

Referring to FIG. 1, an embodiment of an automated cleaning system 100 is shown. In one embodiment, the cleaning component 110 may comprise a cleaning roller (e.g., a brush) that is coupled to a pneumatic actuator 120 (e.g., a pneumatic motor). When the cleaning procedure is initiated, as will be discussed below, the pneumatic actuator 120 may control the rotation of the cleaning component 110. When in contact with labeling components of the conveyor belt bottle filing assembly, the rotation of the cleaning component 110 built up glue and/or ink residue. The labeling components comprise: a vacuum assisted gripper (not shown), a labeler 151 (as shown in FIG. 2), a cutting drum 200 and/or a glue applicator component (not shown)). A pressure gauge 130 may display the pressure of compressed air that is being used by the pneumatic actuator 120 to control the rotation of the cleaning component 110.

In one embodiment, the brush (e.g., the cleaning component) 110 may remove excess glue and/or ink residue from (i) holes or spouts of the labeler 151 from which glue is dispensed onto the plastic bottle and/or the plastic label, (ii) a vacuum assisted gripper and/or (iii) a cutting drum 200. In one embodiment, the labeler 151 is configured to dispense glue as uniformly as possible from each hole or spout onto the plastic bottle and/or plastic label. Cleaning the labeling components aids in uniform dispensing. For example, if one or more holes or spouts is blocked, or partially blocked, the one or more holes or spouts will not dispense the same amount of glue as one or more holes or spouts that is not blocked. Additionally, the vacuum assisted gripper and cutting drum may require cleaning to remove the buildup of glue and/or ink residue in order to ensure the proper, safe and efficient application of glue to labels and/or bottles and the labels to bottles.

In one embodiment, a pneumatic cylinder 160, which will be discussed further below, moves the cleaning component 110 in a straight line (e.g., along a guide rail and bearing 170) to bring the cleaning component 110 into physical contact with the labeling components. In one embodiment, the pneumatic cylinder 160 may be coupled to the cleaning component 110 via a housing 180. In one embodiment, a mechanical arm may connect the pneumatic cylinder 160 to the cleaning component. In one embodiment, the brush 110 has a cylindrical shape and rotates about an axis. The rotating cylindrical brush 110 may scrape glue and/or ink reside that has built up on the labeling components upon physically contacting the labeling components. When the cleaning cycle has ended, the pneumatic cylinder 160 may retract the cleaning component 110.

In another embodiment, the mechanical arm connecting the cleaning component 110 to the pneumatic cylinder 160 may have multiple degrees of freedom (e.g., six degrees of freedom). In such an embodiment, the mechanical arm may maneuver the cleaning component 110 in a plurality of degrees of freedom thereby contacting the labeling components at varying angles. In one embodiment, the cleaning component 110 may contact the labeling components in a tilted manner (e.g., the center axis of a cylindrical brush may not be parallel to the sides of the labeling components). Alternatively, the mechanical arm may include only a remote center of motion that may be positioned by one or more lockable setup joints mounted onto a base.

Furthermore, in some embodiments, the pneumatic cylinder 160 may be controlled, e.g., via a computer program, to vary the amount of contact the cleaning component 110 makes with the labeling components. By changing the pressure at which the cleaning component 110 contacts the labeling components, the cleaning component 110 may remove different levels of excess glue and/or ink residue.

In yet another embodiment, the automated cleaning system 100 includes a reservoir 140 that holds a cleaning solution. In one embodiment, the cleaning solution may be dispensed as a first step prior to the cleaning component (e.g., a brush) 110 beginning to rotate to remove (e.g., scrape off) excess glue and/or ink residue. Alternatively, the cleaning solution may be applied when the cleaning component 110 is rotating at a first speed prior to the cleaning component 110 rotating at a second speed, the second speed being faster than the first speed. In yet other embodiments, the cleaning solution may be applied simultaneous to the cleaning component 110 rotating at one or more speeds. In one embodiment, as will be discussed below, the dispensing may include spraying the cleaning solution onto the brush 110 via a spray mechanism. In such an embodiment, the automated cleaning system 100 includes a spray mechanism to spray the cleaning solution. The spray mechanism may be integrated into the brush or be a distinct component of the automated cleaning system 100.

In one embodiment, the automated cleaning system 100 includes a drying mechanism. For example, the drying mechanism may be an air knife component that forces air at a high pressure against a surface (e.g., a surface of one or more of the labeling components) in order to remove water and/or remaining cleaning solution. Furthermore, the air knife may remove excess glue and/or ink residue that was not removed by the brush and cleaning solution during the cleaning cycle. The time during which the drying mechanism operates may be referred to as the “drying cycle.”

In one embodiment, the automated cleaning system 100 may perform one or more of the following: (1) determine the opportune time to take the conveyor belt bottle filling assembly down for a cleaning; (2) stop the conveyor belt bottle filling assembly automatically; (3) wait for the conveyor belt bottle filling assembly to empty; (4) engage the brush and apply the cleaning solution; (5) determine when the cleaning cycle finishes; and (6) restart the conveyor belt bottle filling assembly.

In some embodiments, the automated cleaning system 100 may determine the opportune time to take down the conveyor belt bottle filling assembly for cleaning based on experiential knowledge and/or predefined rules (e.g., one or more predetermined programs that control when the automated cleaning system 100 takes down the conveyor belt bottle filling assembly for cleaning).

Referring to FIG. 2, an embodiment illustrating interactions between components of the automated cleaning system of FIG. 1 is shown. Herein, the labeling components and automated cleaning system 100 are shown in greater detail than in the illustration of FIG. 1. A plurality of holes are seen on the labeler 151 for dispensing glue. The cutting drum 200, as will be discussed below, is shown to be adjacent to the labeler 151 in the conveyor belt bottle filling assembly. In one embodiment, the brush 110 may be only in physical contact with one of the labeler 151, the vacuum assisted gripper (not shown) and the cutting drum 200 at one point in time. However, in a second embodiment, the brush 110 may be in contact each simultaneously. FIG. 2 also provides another illustration of the pneumatic motor 120 and the reservoir 140, as discussed above with respect to FIG. 1.

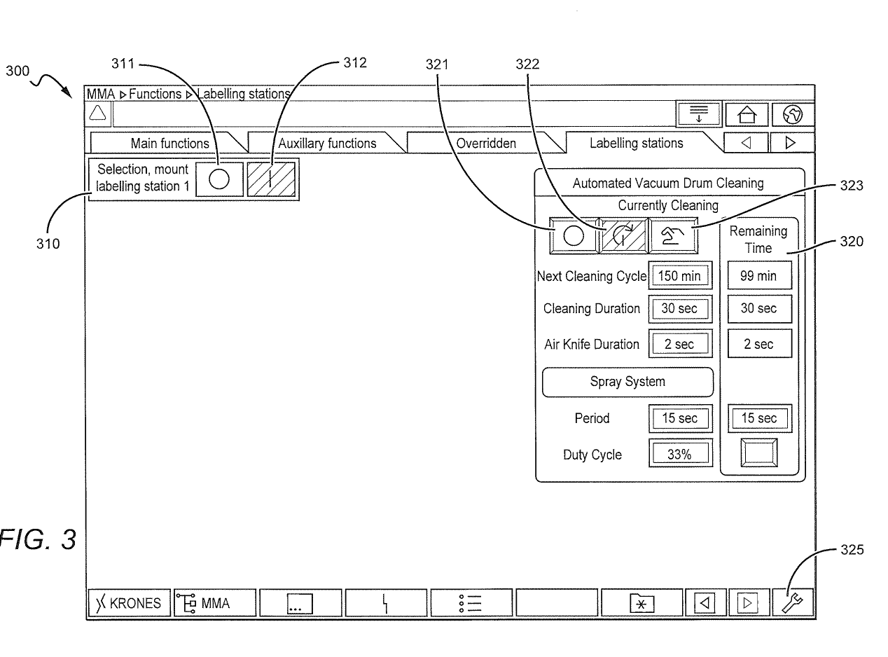

Referring to FIG. 3, an illustration of an example graphical user interface (GUI) screen associated with the automated cleaning system 100 of FIG. 1 is shown. Herein, screen 300 features a plurality of display areas including a power display area 310 and an automated cleaning selection area display 320. The power display area 310 is shown to include a power off button 311 and a power on button 312. The automated cleaning selection area display 320 is shown to include a plurality of buttons 321-323 presenting a user with various cleaning cycle selection options. For example, the screen 300 includes presents a user with three cleaning cycle selection options via the following buttons: (1) a power off button 321; (ii) an automatic cleaning cycle button 322; and (iii) a manual cleaning cycle button 323. Furthermore, other buttons may be present such as a settings button 325. The illustration of FIG. 3 shows the power on button 312 and the automatic cleaning cycle button 322 are selected via striped markings on the buttons.

As discussed above, when selected, the automatic cleaning cycle may determine the opportune time to pause operation of the conveyor belt bottle filling assembly, in particular, the labeling components of the conveyor belt bottle filling assembly, for a cleaning. Additionally, when the automatic cleaning cycle is selected, the automated cleaning system 100 may stop the labeling components of the conveyor belt bottle filling assembly, wait for the labeling components to empty (e.g., complete the labeling process for any plastic bottles currently being handled by the labeling components), engage a cleaning component (e.g., a brush) 110, optionally dispense a cleaning solution, and restart the labeling components when the cleaning cycle has completed. The automatic cleaning cycle may be preconfigured with a predetermined cleaning cycle time (e.g., how long the brush is in contact with the labeling components) and a predetermined amount of cleaning solution to dispense. Additionally, button 323, manual selection of the cleaning cycle, allows a user to manually initiate a cleaning cycle.

The display area 324 may present a user with information related to the remaining time until (i) the next cleaning cycle begins, (ii) the current cleaning cycle is completed, if applicable, (iii) the current air knife process is completed, if applicable, and/or (iv) the current cleaning spray system is completed, if applicable. Additional information may be presented to the user such as configurable, or preconfigured data that describes (a) the time until the next cleaning cycle begins, (b) the duration of a cleaning cycle, (c) the duration of an air knife process, (d) the duration of a spray cycle, and/or (e) the duty cycle spraying during a spray cycle.

In one embodiment, the time remaining until the next cleaning cycle may be influenced by one or more factors including, whether a database table recording the input/out of the automated cleaning system 100 is empty, the infeed of the automated cleaning system 100 and/or the current operation state of an adjacent system of labeling components. In one embodiment, the spraying of the cleaning solution may be controlled by adjusting the period length and duty cycle (e.g., percentage of duration of the cleaning cycle that the cleaning solution is being dispensed). For example, the spray cycle may be 20 seconds and the duty cycle may be 25%. Therefore, during a cleaning cycle, the spray system will spray for 5 seconds every 20 seconds during the cleaning cycle (e.g., the spray system will spray the cleaning solution for 5 seconds and the cleaning cycle will restart 15 seconds after the spraying is completed for a total spray cycle time of 20 seconds).

The cleaning process may be initiated in one of a plurality of scenarios. In one embodiment, the cleaning process may be initiated when one or more of the following occur: (i) a timer expires indicating a predetermined amount of timed since the last cleaning cycle has expired, (ii) a database is empty (e.g., a database including entries for bottles entering and leaving the conveyor belt bottle filling assembly), (iii) the conveyor belt bottle filling assembly is operating at a first or second speed, and/or (iv) an adjacent labeling component is operating (e.g., so that adjacent labeling components are not operated at the same time).

In a second embodiment, the cleaning process may be initiated when one or more of the following occur: (i) the timer indicating a predetermined amount of timed since the last cleaning cycle is within a predetermined time period (e.g., 30 minutes) of expiring, and/or (ii) the conveyor belt bottle filling assembly is overloaded such that there is an excess of bottles in a queue waiting to have labels applied (e.g., a backup of bottles on the conveyor belt bottle filling assembly).

In a third embodiment, the cleaning process may be initiated manually. For example, a user may utilize a GUI similar to the GUI of FIG. 3 to manually initiate a cleaning cycle.

In some embodiments, a cleaning cycle may occur at predetermined time intervals, for example, every 2 hours. The cleaning cycle may also have a total duration of less and 60 seconds. Alternatively, the duration of the cleaning cycle may be configured to be greater than 60 seconds. In one embodiment, the frequency and/or duration of the cleaning cycle may vary according to time of day or the day of the week. For example, the automated cleaning system 100 may require less frequent cleaning when the machine is run overnight. As a second example, during overnight operation of the automated cleaning system 100. cleaning cycles lasting less than the duration of cleaning cycles during typical business hours. Alternatively, the duration of one or more cleaning cycles during overnight operation may be longer than those during typical business hours. In one embodiment, the automated cleaning system 100 may be configured so that cleaning cycles may occur less frequently during weekends and holidays than during normal business days.

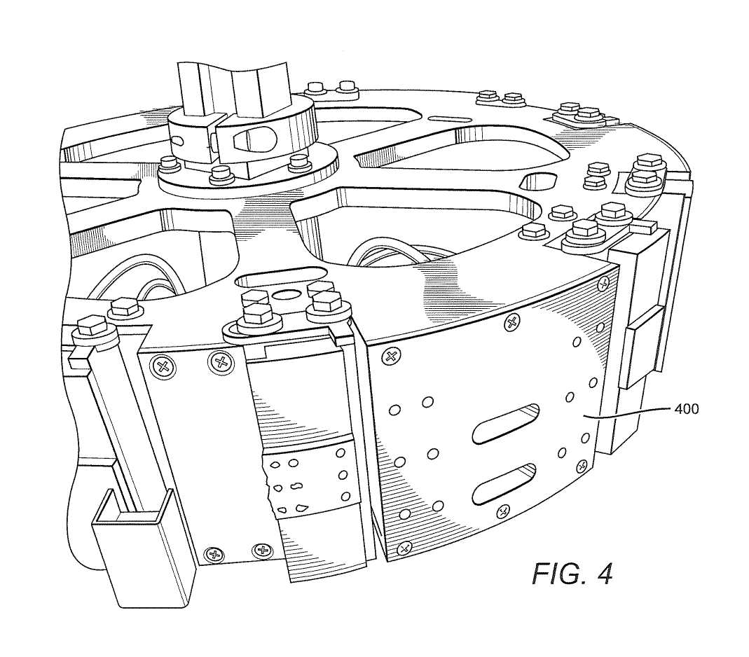

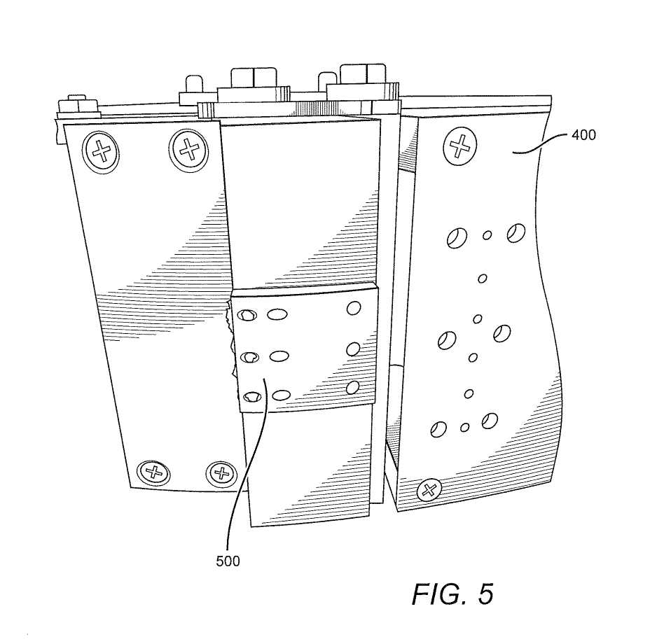

Referring to FIG. 4, an illustration of an exemplary embodiment of the cutting drum 200 of FIG. 2 is shown. During normal labeling operations, the cutting drum 200 and the vacuum assisted gripper (not shown) acquire a buildup of glue and/or ink residue. For example, the vacuum assisted gripper holds the label that is to be applied to a bottle while glue is applied. Once the glue is applied (to the bottle and/or the label), the label may be applied to the bottle. During this process, excess glue and/or ink may buildup on the one or more of the labeling components (e.g., the vacuum assisted gripper, the cutting drum 200, or the labeler 151). When the glue and/or ink residue reaches a predetermined threshold level, the cutting drum 200 and the vacuum assisted gripper drum need to be cleaned to remove at least a portion of the glue and/or ink residue. Referring to FIG. 5, a second perspective of the cutting drum 200 of FIGS. 2 and 4 is shown. The second perspective of the cutting drum 200 provides an example of the glue and/or ink residue 500 that may buildup on the cutting drum 200.

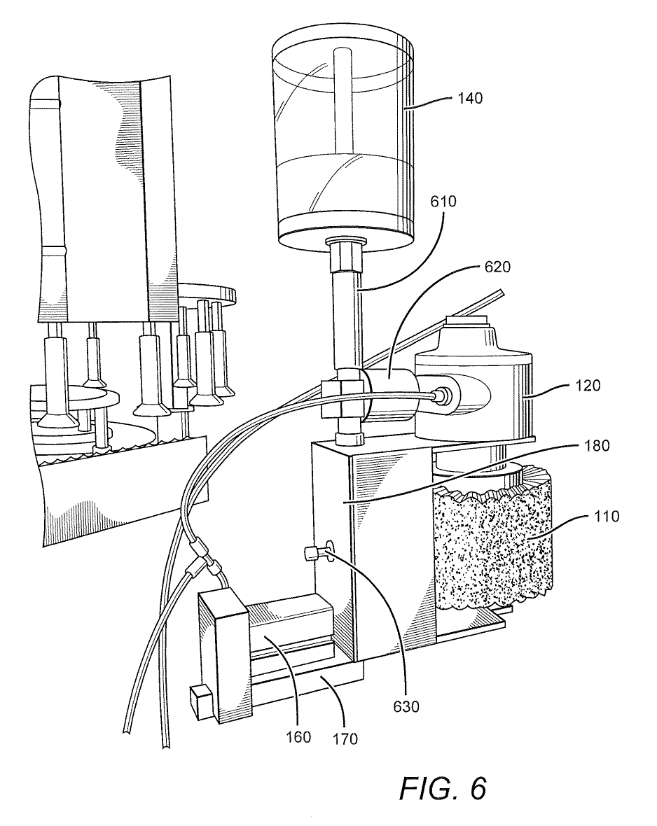

Referring to FIG. 6, an exemplary embodiment of an automated cleaning system is shown. The brower brush system 600 includes a pneumatic motor 120, a brush 110, a reservoir 140, a check valve 610, an atomizer 620, a housing 180, a pneumatic cylinder 160 and a guide rail and bearing 170. The brower brush system 600 operates in a similar manner as to the description above relating to the automated cleaning system 100. In the embodiment illustrated in FIG. 6, the pneumatic motor 120 is coupled to the brush 110. The pneumatic motor 120 operates to rotate the brush 110 when the brower brush system 600 is operating in a cleaning cycle. In some embodiments, the pneumatic motor 120 may be programmed to rotate the brush 110 at one or more predefined speeds (e.g., may be dependent on parameters of the cleaning cycle). In one embodiment, the pneumatic motor 120 may be programmed to alternate the rotational speed of the brush 110 during a cleaning cycle based on, for example, the completion percentage of the cleaning cycle (e.g., 25%, 50%, 75%, etc.), the amount of cleaning solution present on either the cutting drum 200 and/or the vacuum assisted gripper (not shown).

The brush 110 is shown to multiple bundles of bristles protruding from a cylindrical base but in other embodiments may include other configurations. Examples of other configurations include, but are not limited or restricted to, multiple rows of bristles, multiple columns of bristles, specific patterns of bristle bundles, or any combination thereof.

In one embodiment, the brower brush system 600 includes a reservoir 140 for holding a cleaning solution. In the illustration of FIG. 6, the reservoir 140 is shown holding a cleaning solution in a liquid form. In a second embodiment, the reservoir 140 may include a plurality of compartments that may house a cleaning solution in a gel or powdered form in a first compartment and a liquid (e.g., water) in a second compartment. In such an embodiment, the cleaning solution not in a liquid form mixes with the liquid, e.g., in the second compartment or in a third compartment, prior to being dispensed onto the brush 110, as will be discussed below. Furthermore, the reservoir and inclusion of a cleaning solution are optional features. Therefore, in other embodiments, the reservoir 140 and cleaning solution may not be present.

The reservoir 140 may be coupled to the check valve 610. The coupling prevents any substances (e.g., water, cleaning solution, a combination thereof, etc.) from entering the reservoir 140. The check valve 610 may be any type of check valve including, but not limited or restricted to, a ball check valve, a diaphragm check valve, a swing check valve, a stop-check valve, etc.

The brower brush system 600 may also include an atomizer 620. The atomizer 620 may produce a spray that is dispensed through a spray mechanism that will be discussed below. The atomizer 620 may draw the cleaning solution in a liquid form from the reservoir 140 and convert the liquid into small droplets (i.e., producing a spray). The spray mechanism may then dispense the spray onto the brush 110. As is illustrated in FIG. 6, and will be discussed in depth below, the spray mechanism is housed in the housing 180. The housing 180 may have the purpose of supporting one or more of the spray mechanism, the atomizer 620, the check valve 610 and/or the reservoir 140. In one embodiment, the housing 180 may include a spray control mechanism 630, as will be discussed in further detail below. Additionally, the housing 180 may serve to direct the spray of the cleaning solution onto the brush 110 and not elsewhere in the operating environment surrounding the spray mechanism.

The brower brush system 600 may also include a pneumatic cylinder 160 and a guide rail and bearing 170. The pneumatic cylinder 160 may operate to move the brush 110 to be in contact with the cutting drum 200 and/or the vacuum assisted gripper. In one embodiment, the pneumatic cylinder 160 may operate to move the brush 110 and one or more of at least the housing 180, the spray mechanism, the atomizer 620, the check valve 610, the reservoir 140 and/or the motor 120. Similarly, when a cleaning cycle ends, the pneumatic cylinder 160 may move one or more of the brush 110, the housing 180, the spray mechanism, the atomizer 620, the check valve 610, the reservoir 140 and/or the motor 120 such that the brush 110 is no longer in contact with the cutting drum 200 and/or the vacuum assisted gripper. In one embodiment, the pneumatic cylinder 160 operates to cause the brush 110 to move linearly toward, and away from, the cutting drum 200 and/or the vacuum assisted gripper. In yet another embodiment, the pneumatic cylinder may take another shape such that the pneumatic cylinder may operate to move, at least, the brush 110 in one more planes (e.g. the pneumatic cylinder having six of degrees of freedom). In such an embodiment, the guide rail and bearing 170 may move in a corresponding manner.

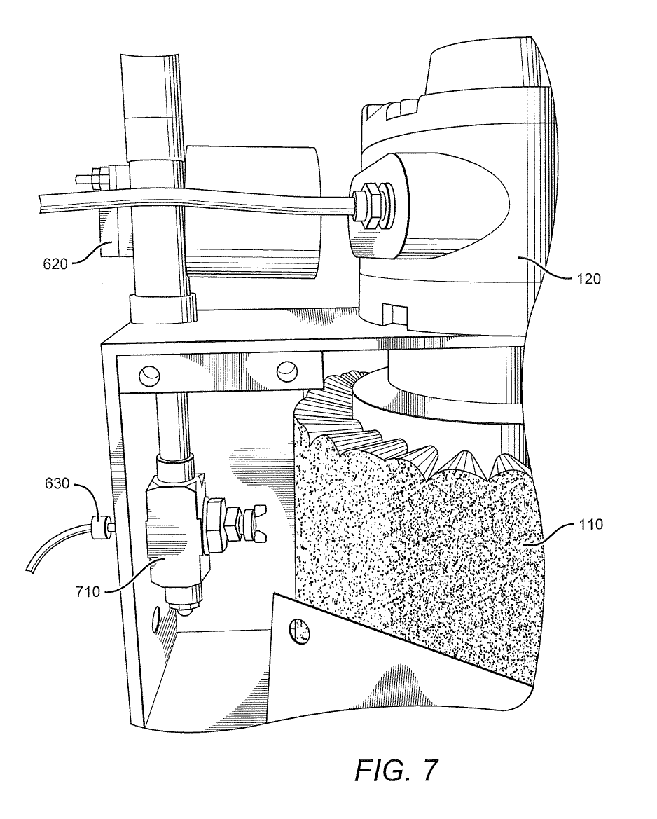

Referring to FIG. 7, a second perspective of the exemplary embodiment of an automated cleaning system as illustrated in FIG. 6 is shown. A spray mechanism 710 is shown to be coupled to the atomizer 620 through the housing 180. The housing 180 may provide direction to the spray, possibly shielding the spray from coming into contact with one or more pieces of equipment surrounding the automated cleaning system. Additionally, the spray mechanism 710 may be coupled to a spray control mechanism 630 (e.g., a spray control knob) that is configured to control the amount of spray dispensed from the spray mechanism 710. In one embodiment, as shown in FIG. 7, the spray control mechanism 630 may be a manual knob that is tightened or loosened by a user. In another embodiment, the spray control mechanism 630 may be an electronic control that is programmable by a user and/or may be programmed prior to installation. Additionally, FIG. 7 provides a second illustration of the cleaning component 110 and the motor 120, as discussed above with respect to, at least, FIG. 1.

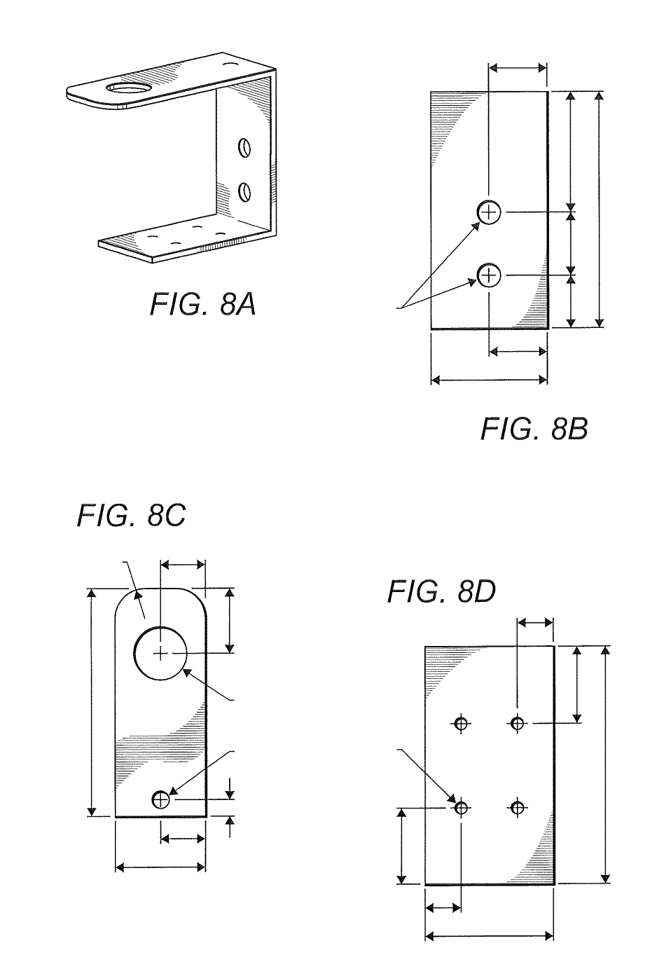

Referring to FIGS. 8A-8D, example illustrations of the housing 180 are shown. FIG. 8A illustrates one embodiment of the physical structure of the housing, having a top plate, a back plate and a bottom plate. FIGS. 8B-8D illustrate diagrams of the back plate, top plate and bottom plate respectively. The measurements present in the FIGS. 8B-8D merely represent one embodiment that the housing 180 may take. Those having ordinary skill in the art will recognize that the housing may take alternative forms, having one or more plates, having fewer plates, having alternative dimensions and/or having more or fewer holes.

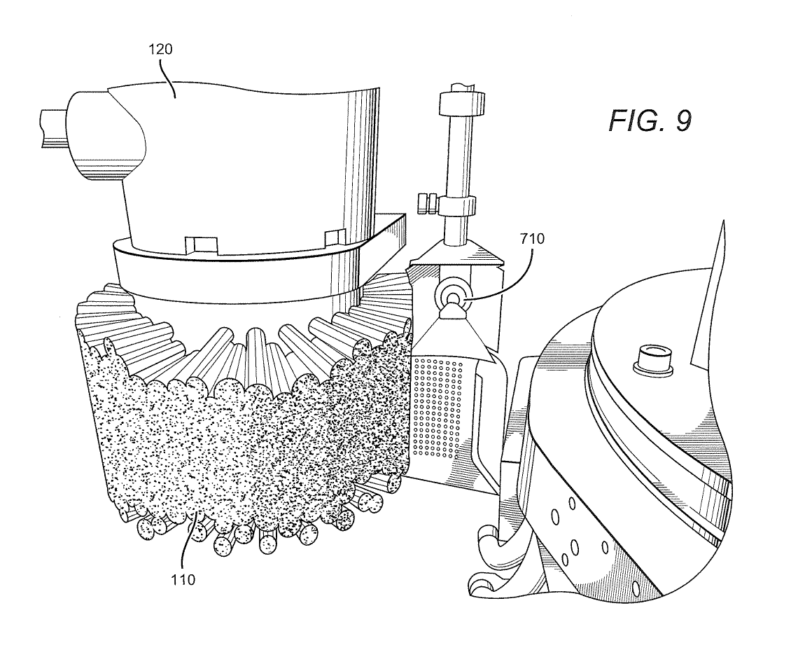

Referring to FIG. 9, an example illustration of a cleaning component 110 and a spray mechanism 710 is shown. As discussed above, the cleaning component 110 may comprise a cleaning roller (e.g., a brush) that is coupled to a pneumatic actuator 120 (e.g., a pneumatic motor) that may be configured to control the rotation of the cleaning component 110. The spray mechanism 710 may dispense (e.g., spray) a liquid and/or liquid-foam mixture before, during and/or after a bottle contacts the cleaning component 110.

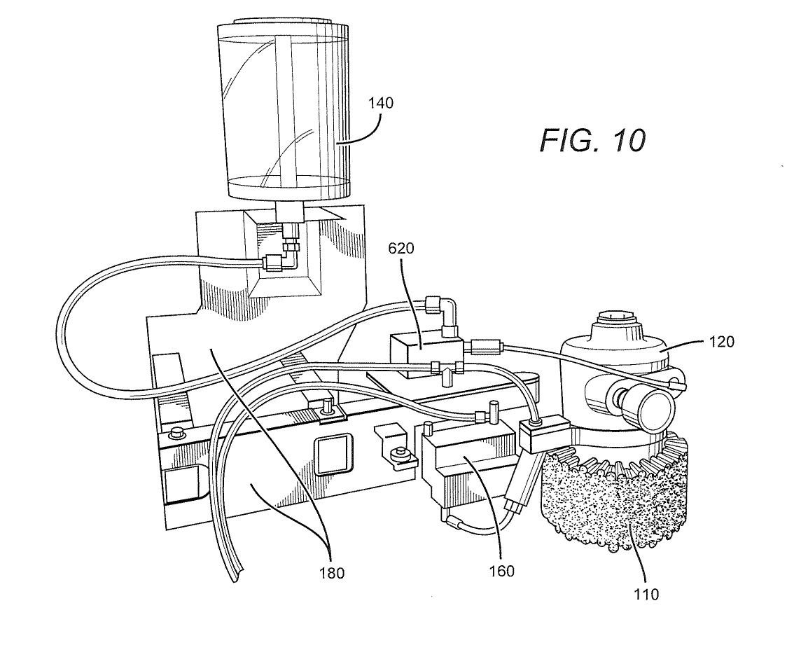

Referring now to FIG. 10, a second embodiment of the automated cleaning system of FIG. 1 is shown. In a first embodiment, the cleaning component 110 comprises a brush coupled to a pneumatic actuator 120. The cleaning component 110 and the pneumatic actuator 120 may be further coupled to a pneumatic cylinder 160 in order to move the cleaning component 110 along a guide rail and bearing 170, thus bringing the cleaning component 110 into physical contact with one or more labeling components. Additionally, the housing 180 may have the purpose of housing and/or supporting one or more of the spray mechanism 710 of FIG. 9, the atomizer 620, the check valve 610 of FIG. 6 and/or the reservoir 140. As mentioned above, the housing 180 may serve to direct the spray of the cleaning solution onto the brush 110 and not elsewhere in the operating environment surrounding the spray mechanism

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

1. An automated cleaning system comprising:
a cleaning component integrated into a conveyor belt bottle filling assembly; and
a pneumatic actuator integrated into the conveyor belt bottle filling assembly and communicatively coupled to the cleaning component to control a movement of the cleaning component for removing residue from a labeling component of the conveyor belt bottle filling assembly.

2. The automated cleaning system of claim 1, wherein the pneumatic actuator is preconfigured to automatically pause the conveyor belt bottle filling assembly at predefined time intervals and initiate a cleaning cycle.

3. The automated cleaning system of claim 1, wherein the pneumatic actuator is communicatively coupled to the cleaning component via a mechanical arm, the pneumatic actuator transmits one or more electrical signals to the mechanical arm to control a movement of the cleaning component.

4. The automated cleaning system of claim 1 further comprising:
a drying component.

5. The automated cleaning system of claim 4, wherein the drying component is an air knife mechanism.

6. The automated cleaning system of claim 1 further comprising:
a container that holds a cleaning solution; and
a spray mechanism coupled to the container, wherein the cleaning solution is dispensed during a cleaning cycle of the automated cleaning system.

7. An apparatus for cleaning one or more components of a bottle labeling assembly, the apparatus comprising:
a pneumatic motor;
a cleaning component coupled to the pneumatic motor; the cleaning component including a plurality of bristles and configured to rotate according to operation of the pneumatic motor;
a guide rail and bearing coupled to at least one of the cleaning component or the pneumatic motor; and
a pneumatic cylinder coupled to the guide rail and bearing and at least one of the cleaning component or the pneumatic motor, the pneumatic cylinder operative to move the cleaning component and the pneumatic motor along the guide rail and bearing.

8. The apparatus of claim 7 further comprising:
a reservoir to hold a cleaning solution;
a spray mechanism to spray the cleaning solution onto the plurality of bristles of the cleaning component; and
an atomizer coupled to the reservoir and the spray mechanism, the atomizer to atomize a liquid form of the cleaning solution from the reservoir, wherein the spray mechanism sprays an atomized version of the cleaning solution.

9. The apparatus of claim 8 further comprising:
a check valve coupling the reservoir to the atomizer to prevent any backflow into the reservoir.

10. The apparatus of claim 8 further comprising:
a housing that houses the spray mechanism, the housing coupling the pneumatic cylinder to the at least one of the cleaning component or the pneumatic motor, wherein the housing directs the spray.

11. The apparatus of claim 8 further comprising:
a spray control mechanism to control the amount of spray dispensed by the spray mechanism, the spray control mechanism being coupled to the spray mechanism.

12. The apparatus of claim 7, wherein the pneumatic cylinder moves the cleaning component and the pneumatic motor along the guide rail and bearing in a straight line.

13. A method of cleaning one or more components of a bottle labeling assembly comprising:
determining the one or more components of the bottle labeling assembly are empty;
moving a cleaning component into contact with the one or more components of the bottle labeling assembly with a pneumatic cylinder;
rotating the cleaning component with a pneumatic motor for a predetermined amount of time to remove excess residue; and
removing the cleaning component from contact with the one or more components of the bottle labeling assembly with the pneumatic cylinder when the predetermined amount of time has elapsed.

14. The method of claim 13, wherein the cleaning component is moved along a guide rail using the pneumatic cylinder.

15. The method of claim 13 further comprising:
atomizing a cleaning solution; and
spraying the atomized cleaning solution onto the cleaning component.

16. The method of claim 15, wherein the atomized cleaning solution is sprayed prior to rotating the cleaning component.
